(19) United States
(12) Patent Application Publication
(10) Pub. No.: US 2026/0276503 A1
(43) Pub. Date: Sep. 17, 2026

(54) JIG, IMPACT TEST METHOD USING THE SAME, AND ELECTRONIC DEVICE

(71) Applicant: Samsung Display Co., LTD., Yongin-si (KR)

(72) Inventor: GABTAE KIM, Yongin-si (KR)

(21) Appl. No.: 19/411,923

(22) Filed: Dec. 8, 2025

(30) Foreign Application Priority Data
Mar. 12, 2025 (KR) 10-2025-0032103

(51) Int. Cl. G01N 3/32

(52) U.S. Cl. CPC G01N 3/32; G01N 2203/001; G01N 2203/0262; G01N 2203/04

(57) ABSTRACT

A jig includes: a main frame including a plurality of plates, each of the plurality of plates having a first surface, to which a display module is attached, and a second surface opposite to the first surface; a bezel frame combined with the main frame and surrounding at least a portion of the main frame in a plan view; a hinge combined with the second surfaces of the plurality of plates, connecting adjacent plates of the plurality of plates, and capable of fixing an unfolded state of the display module; and a folding fixing part combined with the bezel frame and capable of fixing a folded state of the display module.

### CROSS-REFERENCE TO RELATED APPLICATION

This application claims priority to Korean Patent Application No. 10-2025-0032103, filed on Mar. 12, 2025, and all the benefits accruing therefrom under 35 U.S.C. §119, the content of which in its entirety is herein incorporated by reference.

### BACKGROUND

### 1. Field

The present disclosure relates generally to a jig and an impact test method using the jig. More particularly, the present disclosure relates to a jig combined with a display module and an impact test method using the jig.

### 2. Description of the Related Art

With the development of information technology, the importance of a display device, which is a connection medium between a user and information, has been highlighted. For example, the use of display devices such as liquid crystal display (LCD) device, organic light emitting diode (OLED) display device, plasma display panel (PDP) device, quantum dot display device or the like is increasing.

Recently, with the recent technological development of a display device, various types of electronic devices are being developed. For example, a flexible electronic device, a foldable display vice, etc. that can be folded are being developed. The flexible electronic device, the foldable electronic device, etc. which can be transformed into various shapes, are easy to carry and can improve user convenience.

Since the foldable electronic device operates in various modes, there is a need for an environment for durability evaluation of the display module that is similar to the environmental conditions under which the foldable electronic device operates in various modes.

### SUMMARY

Embodiments provide a jig that is combined with a display module to create an actual use environment of the display module that operates in multiple modes.

Embodiments provide an impact test method that evaluates defects occurring in an active use environment of a display module that operates in multiple modes using the jig.

Embodiments provide an electronic device including a display module, wherein an impact test is performed using the jig.

A jig according to an embodiment of the present disclosure includes: a main frame including a plurality of plates, each of the plurality of plates having a first surface, to which a display module is attached, and a second surface opposite to the first surface; a bezel frame combined with the main frame and surrounding at least a portion of the main frame in a plan view; a hinge combined with the second surfaces of the plurality of plates, connecting adjacent plates of the plurality of plates, and capable of fixing an unfolded state of the display module; and a folding fixing part combined with the bezel frame and capable of fixing a folded state of the display module.

In an embodiment, the jig may further include a gap adjusting part which is combined with the bezel frame and adjusts a gap between the plurality of plates.

In an embodiment, the gap adjusting part may include a first gap adjusting part having a straight-line shape and a second gap adjusting part having a Z- shape.

In an embodiment, the hinge may include a first hinge and a second hinge spaced apart from each other. A first width of the first hinge and a second width of the second hinge may be different from each other.

In an embodiment, the hinge may include a plurality of joint portions.

In an embodiment, the folding fixing part may have a U- shape.

In an embodiment, the display module may include a first display area, a second display area, a third display area, a peripheral area surrounding at least a portion of the first to third display areas in the plan view, a first folding area between the first display area and the second display area, and a second folding area between the second display area and the third display area. The plurality of plates may correspond to the first to third display areas, respectively. The bezel frame may correspond to the peripheral area.

In an embodiment, the display module may be out-folded in the first folding area and in-folded in the second folding area. The hinge may include a first hinge corresponding to the first folding area and a second hinge corresponding to the second folding area.

In an embodiment, the jig may further include an attachment guide defining a plurality of resting grooves corresponding to the plurality of plates, respectively, the attachment guide on which the plurality of plates are rested.

In an embodiment, when the plurality of plates are rested on the attachment guide, the second surfaces of the plurality of plates may contact the attachment guide.

An impact test method according to an embodiment of the present disclosure includes: providing a jig including a main frame, which includes a plurality of plates, a bezel frame, a hinge, and a folding fixing part; attaching a display module to first surfaces of the plurality of plates; combining the bezel frame with the main frame to surround at least a portion of the main frame in a plan view; combining the hinge with second surfaces opposite to the first surfaces of the plurality of plates to connect adjacent plates of the plurality of plates, thereby forming a first falling object including the display module fixed in an unfolded state; colliding the first falling object with an impact plate; folding the bezel frame and the display module attached to the plurality of plates; combining the folding fixing part with the bezel frame, thereby forming a second falling object including the display module fixed in a folded state; and colliding the second falling object with the impact plate.

In an embodiment, the jig may further include a gap adjusting part which adjusts a gap between the plurality of plates.

In an embodiment, the method may further include combining the gap adjusting part with the bezel frame after the folding of the bezel frame and the display module.

In an embodiment, when the display module included in the second falling object is fixed in a completely folded state, the plurality of plates of the main frame included in the second falling object may be substantially parallel from each other.

In an embodiment, when the display module included in the second falling object is fixed in a not completely folded state, the plurality of plates of the main frame included in the second falling object may not be substantially parallel from each other.

In an embodiment, the method may further include removing the hinge after the forming of the first falling object.

In an embodiment, the hinge may include a plurality of joint portions, and the hinge may be bent together with the display module in the folding of the bezel frame and the display module.

In an embodiment, the display module may include a first display area, a second display area, a third display area, a peripheral area surrounding at least a portion of the first to third display areas in the plan view, a first folding area between the first display area and the second display area, and a second folding area between the second display area and the third display area. The display module may be out-folded in the first folding area and in-folded in the second display area. The hinge may include a first hinge corresponding to the first folding area and a second hinge corresponding to the second folding area.

In an embodiment, the colliding of the first falling object with the impact plate may include colliding each of an upper surface, a lower surface, a side surface, a front surface, and a back surface of the first falling object with the impact plate. The colliding of the second falling object with the impact plate may include colliding each of an upper surface, a lower surface, a side surface, a front surface, and a back surface of the second falling object with the impact plate.

An electronic device according to an embodiment of the present disclosure includes: a display module in which an impact test is performed using a jig; and a processor which transmits an image data signal and an input control signal to the display module. The jig includes: a main frame including a plurality of plates, each of the plurality of plates having a first surface attached to the display module and a second surface opposite to the first surface; a bezel frame combined with the main frame and surrounding at least a portion of the main frame in a plan view; a hinge combined with the second surfaces of the plurality of plates, connecting adjacent plates, and capable of fixing an unfolded state of the display module; and a folding fixing part combined with the bezel frame and capable of fixing a folded state of the display module.

A jig according to embodiments of the present disclosure may be combined with a display module to change the shape of the display module. The display module may be folded in a Z-shape by being out-folded with respect to a first folding axis and in-folded with respect to a second folding axis spaced apart from the first folding axis.

A falling object formed by combining the jig and the display module may have a set environment similar to an electronic device (e.g., a foldable electronic device) that operates in multiple usage modes. That is, an evaluation of defects occurring in an actual usage environment of the display module that operates in multiple usage modes may be performed by using the jig.

### BRIEF DESCRIPTION OF THE DRAWINGS

Illustrative, non-limiting embodiments will be more clearly understood from the following detailed description in conjunction with the accompanying drawings.

FIG. 1 is a perspective view illustrating an impact test apparatus according to an embodiment of the present disclosure.

FIGS. 2A and 2B are perspective views illustrating falling objects evaluated by the impact test apparatus of FIG. 1.

FIG. 3 is an exploded perspective view illustrating a jig according to an embodiment of the present disclosure.

FIGS. 4-9, and 10 are views illustrating a method of combining the jig of FIG. 3 with a display module.

FIGS. 11-16, and 17 are views illustrating a method of combining the jig of FIG. 3 with a display module.

FIG. 18 is an exploded perspective view illustrating a jig according to an embodiment of the present disclosure.

FIGS. 19 and 20 are views illustrating a method of combining the jig of FIG. 18 with a display module.

FIGS. 21 and 22 are cross-sectional views illustrating some steps of an impact test method according to an embodiment of the present disclosure.

FIG. 23 is a block diagram of an electronic device according to an embodiment of the present disclosure.

FIG. 24 is a view illustrating an example of the electronic device of FIG. 23 is implemented as a foldable electronic device.

### DETAILED DESCRIPTION

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

"About" or "substantially equal" as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, "substantially parallel" can mean within one or more standard deviations, for example, forming 2 degrees or less.

Hereinafter, embodiments of the present disclosure will be described in detail with reference to the accompanying drawings. The same reference numerals are used for the same components in the drawings, and redundant descriptions of the same components will be omitted.

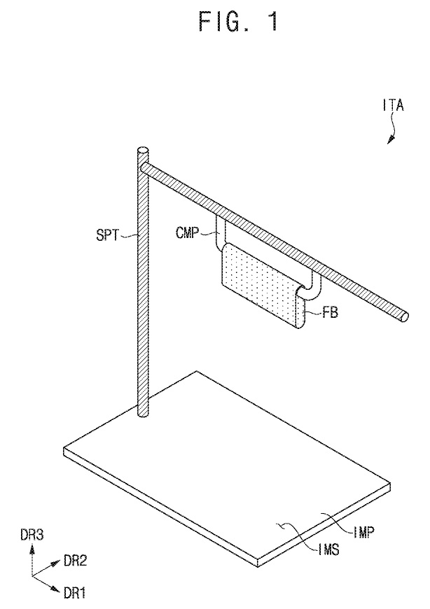

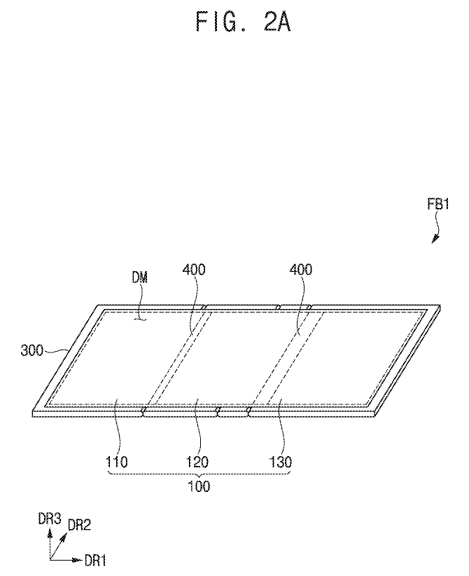

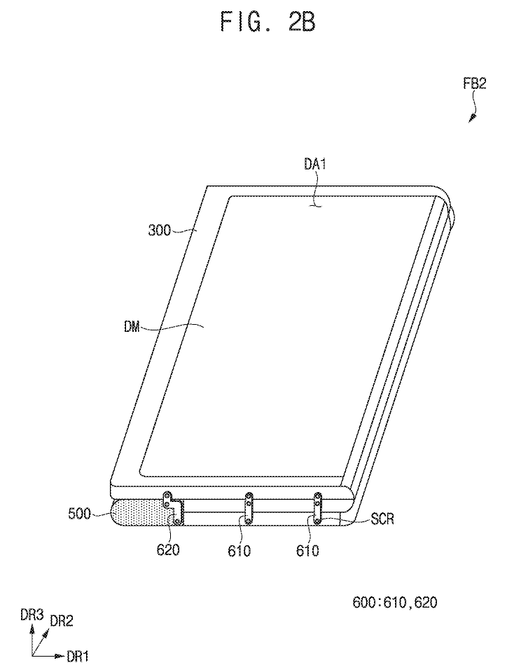

FIG. 1 is a perspective view illustrating an impact test apparatus according to an embodiment of the present disclosure. FIGS. 2A and 2B are perspective views illustrating falling objects evaluated by the impact test apparatus of FIG. 1.

In this specification, a plane may be defined by a first direction DR1 and a second direction DR2 intersecting the first direction DR1. For example, the first direction DR1 and the second direction DR2 may be perpendicular to each other. A direction normal to the plane may be a third direction DR3. In other words, the third direction DR3 may be perpendicular to each of the first direction DR1 and the second direction DR2.

Referring to FIG. 1, an impact test apparatus ITA according to an embodiment of the present disclosure may include a clamp CMP, a support SPT, and an impact plate IMP.

The clamp CMP may grip a falling object FB. The clamp CMP may grip the falling object FB by applying a gripping force, and may drop the falling body FB by releasing the gripping force applied to the falling body FB by a predetermined action. For example, the clamp CMP may drop the falling body FB in the opposite direction of the third direction DR3.

The falling object FB may be an object that is subjected to a drop impact test by the impact test apparatus ITA to evaluate whether defects occur. The falling object FB may include a display module. That is, in an embodiment, the impact test apparatus ITA may be an apparatus for evaluating whether defects occur in the display module included in the falling object FB due to a collision caused by dropping. For example, the display module may be a display module used in small and medium-sized products such as a tablet PC, a laptop, a smartphone, a game console, a car navigation system, a computer monitor, or the like. However, the present disclosure is not necessarily limited thereto.

In an embodiment, the display module included in the falling object FB may be a component included in a foldable electronic device having a plurality of usage modes. That is, the impact test apparatus ITA may be an impact test apparatus capable of evaluating each of the plurality of usage modes of the foldable electronic device.

The support SPT may be connected to the clamp CMP. That is, the clamp CMP may be connected to an upper portion of the support SPT and may be positioned a predetermined height away from the impact plate IMP. A height of the support SPT may be selected according to an actual usage environment of the electronic device. For example, the height of the support SPT may be selected according to the actual use environment of a small or medium-sized electronic device. However, the present disclosure is not necessarily limited thereto, and the height of the SPT may be variously changed according to embodiments.

The impact plate IMP may define an impact surface IMS at which the falling object FB falls and impacts. The impact plate IMP may include a rigid material. For example, the impact plate IMP may include granite or metal.

In an embodiment, the impact test apparatus ITA may further include a control part for controlling the operation of the clamp CMP and a height adjustment part for adjusting the height of the support SPT. The control part may control the operation of the clamp CMP to apply a gripping force, or to release the gripping force.

Referring further to FIGS. 2A and 2B, the falling object FB dropped by the impact test apparatus ITA may include a first falling object FB1 and a second falling object FB2. That is, the impact test apparatus ITA may drop any one of the first falling object FB1 and the second falling object FB2 in a single impact test. In other words, the impact test apparatus ITA may be an apparatus that drops the first falling object FB1 to evaluate the falling impact of the first falling object FB1, and subsequently drops the second falling object FB2 to evaluate the falling impact of the second falling object FB2.

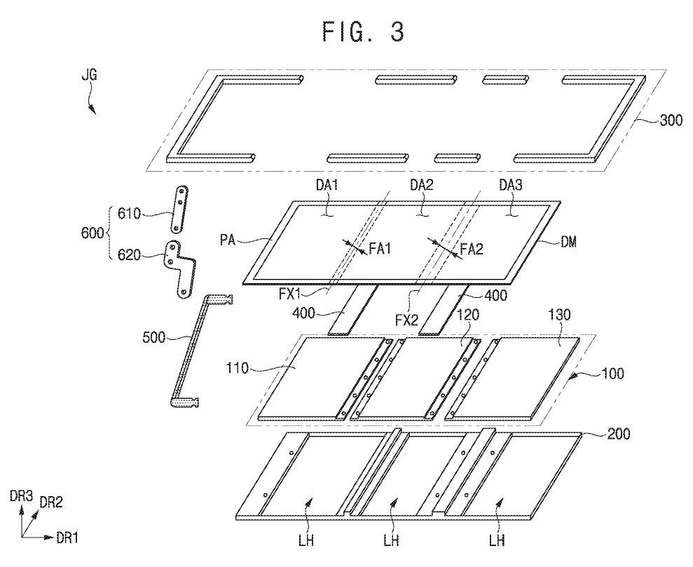

Each of the first falling object FB1 and the second falling object FB2 may include a jig (JG, see FIG. 3) and a display module DM combined to the jig. The display module DM included in each of the first falling object FB1 and the second falling object FB2 may be the same display module operating in different usage modes. For example, the display module DM included in the first falling object FB1 may be in an unfolded state, and the display module DM included in the second falling object FB2 may be in a folded state. A detailed description thereof will be described below with reference to FIG. 3.

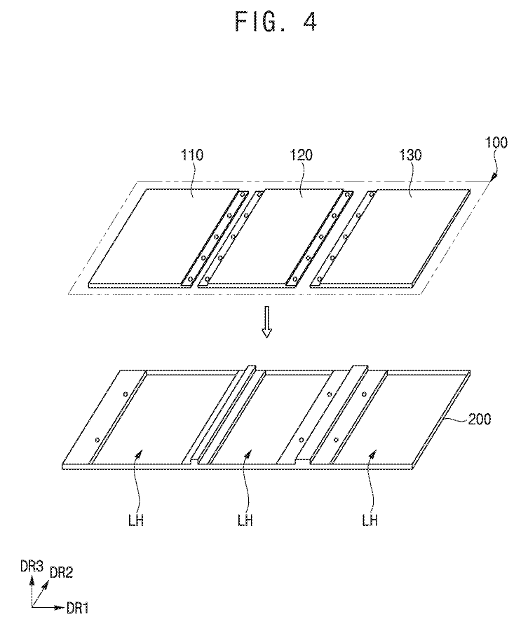

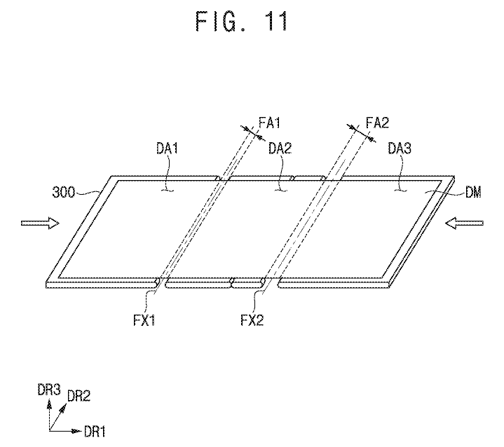

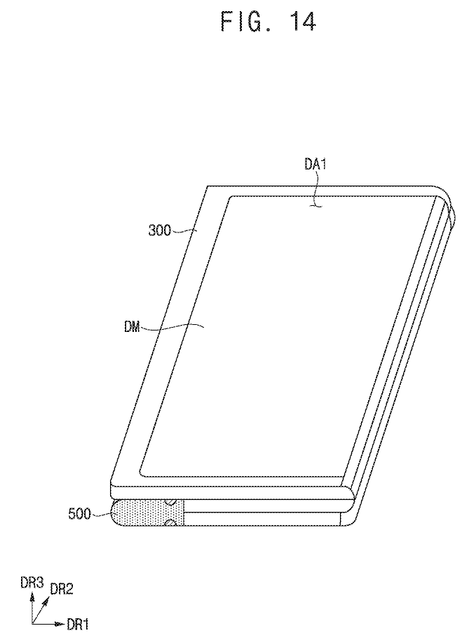

The jig may include a main frame 100, a bezel frame 300, a hinge 400, a folding fixing part 500, and a gap adjusting part 600. The jig may be combined with the display module DM. As illustrated in FIG. 2A, the jig may fix an unfolded state of the display module DM. A detailed description thereof will be described below with reference to FIGS. 4-10. In addition, as illustrated in FIG. 2B, the jig may fix a folded state of the display module DM by changing the shape of the display module DM. A detailed description thereof will be described below with reference to FIGS. 11-17.

FIG. 3 is an exploded perspective view illustrating a jig according to an embodiment of the present disclosure.

Referring to FIG. 3, the jig JG may include the main frame 100, an attachment guide 200, the bezel frame 300, the hinge 400, the folding fixing part 500, and the gap adjusting part 600. The jig JG may be combined with the display module DM. For example, the jig JG may be configured to create a set environment similar to when the display module DM is applied to an actual electronic device by being combined with the display module DM. The jig JG may fix an unfolded state of the display module DM. In addition, the jig JG may fix a folded state of the display module DM by changing the shape of the display module DM.

The display module DM may be a component included in a foldable electronic device. The display module DM may be flexible and may be easily bent or folded. The display module DM may include display areas DA1, DA2, and DA3 and a peripheral area PA.

Each of the display areas DA1, DA2, and DA3 may be defined as an area that displays an image by generating light or adjusting the transmittance of light provided from an external light source. The display areas DA1, DA2, and DA3 may include a first display area DA1, a second display area DA2, and a third display area DA3 that are spaced apart from each other.

The peripheral area PA may not display an image. The peripheral area PA may be positioned around the display areas DA1, DA2, and DA3. For example, the peripheral area PA may surround at least a portion of the display areas DA1, DA2, and DA3 in a plan view. As used herein, the “plan view” is a view in a thickness direction (i.e., third direction DR3) of the jig JG.

In an embodiment, the display module DM may further include a first folding area FA1 that is folded by a first folding axis FX1 and a second folding area FA2 that is folded by a second folding axis FX2 spaced apart from the first folding axis FX1. The first folding area FA1 and the second folding area FA2 may display an image. The first folding area FA1 may be positioned between the first display area DA1 and the second display area DA2 in a plan view. The second folding area FA2 may be positioned between the second display area DA2 and the third display area DA3 in a plan view.

In an embodiment, the display module DM may be out-folded with respect to the first folding axis FX1 and in-folded with respect to the second folding axis FX2. The display module DM may be out-folded in the first folding area FA1 and in-folded in the second folding area FA2. That is, the first display area DA1 and the second display area DA2 may be folded so as not to face each other with respect to the first folding axis FX1. In other words, the display module DM may be folded so that back surfaces of the display module DM face each other with respect to the first folding axis FX1. In addition, the second display area DA2 and the third display area DA3 may be folded so as to face each other with respect to the second folding axis FX2. Accordingly, the display module DM may be folded in a Z-shape. However, the present disclosure is not necessarily limited thereto, and the display module DM may be in-folded with respect to the first folding axis FX1 and out-folded with respect to the second folding axis FX2.

When the display module DM is folded, the display module DM may be folded with a first radius of curvature in the first folding area FA1, and may be folded with a second radius of curvature in the second folding area FA2. In an embodiment, the first radius of curvature and the second radius of curvature may be different from each other. For example, the first radius of curvature may be greater than the second radius of curvature. However, the present disclosure is not necessarily limited thereto, and the first radius of curvature may be smaller than the second radius of curvature. The first radius of curvature and the second radius of curvature may be variously changed according to embodiments.

The main frame 100 may include a plurality of plates 110, 120, and 130 arranged in a direction. For example, the plates 110, 120, and 130 may include a first plate 110, a second plate 120, and a third plate 130 arranged in the first direction DR1. Each of the plates 110, 120, and 130 may have a first surface (e.g., a front surface) and a second surface (e.g., a back surface) opposite to the first surface. The first surfaces of the plates 110, 120, and 130 may be attached to the display module DM. The main frame 100 may serve a role similar to a housing that covers a back surface of the display module DM when the display module DM is applied to an actual electronic device.

The plates 110, 120, and 130 may correspond to the display areas DA1, DA2, and DA3 of the display module DM, respectively. For example, the first plate 110 may correspond to the first display area DA1, the second plate 120 may correspond to the second display area DA2, and the third plate 130 may correspond to the third display area DA3. For example, each of the plates 110, 120, and 130 may have a rectangular planar shape. However, the present disclosure is not necessarily limited thereto, and the planar shape of each of the plates 110, 120, and 130 may vary depending on the planar shape of the display areas DA1, DA2, and DA3 of the display module DM. As used herein, the planar shape may be a shape in a plan view, and “A correspond to B” may mean that A and B overlap each other..

The main frame 100 may be mounded on the attachment guide 200. In an embodiment, the attachment guide 200 may define resting grooves LH corresponding to the plates 110, 120, and 130 of the main frame 100, respectively. That is, the plates 110, 120, and 130 of the main frame 100 may be rested on the resting grooves LH, respectively. When the display module DM is attached to the first surfaces of the plates 110, 120, and 130, the plates 110, 120, and 130 may be rested on the attachment guide 200. That is, the second surfaces of the plates 110, 120, and 130 may contact the attachment guide 200. In an embodiment, the attachment guide 200 may be omitted.

The bezel frame 300 may be combined with the main frame 100. When the bezel frame 300 is combined with the main frame 100, the bezel frame 300 may surround at least a portion of the main frame 100 in a plan view. The bezel frame 300 may correspond to the peripheral area PA of the display module DM. The bezel frame 300 may serve a role similar to a housing covering the peripheral area PA of the display module DM when the display module DM is applied to an actual electronic device.

The hinge 400 may be combined with the main frame 100. For example, the hinge 400 may be combined with the second surfaces (e.g., back surfaces) of the plates 110, 120, and 130. In an embodiment, the hinge 400 may have a rectangular planar shape. The hinge 400 may be connected to a hinge axis of each pair of adjacent plates of the first to third plates 110, 120, and 130, and may connect the adjacent plates. For example, the hinge 400 may be connected to a hinge axis of each of the first plate 110 and the second plate 120, and may connect the first plate 110 and the second plate 120. For example, the hinge 400 may be connected to a hinge axis of each of the second plate 120 and the third plate 130, and may connect the second plate 120 and the third plate 130. In an embodiment, the hinge 400 may fix the an unfolded state of the display module DM attached to the plates 110, 120, and 130.

The folding fixing part 500 may be combined with the bezel frame 300. In an embodiment, the folding fixing part 500 may have a U-shaped planar shape. In an embodiment, when the shape of the display module DM is changed to a folded state, the folding fixing part 500 may fix the folded state of the display module DM attached to the plates 110, 120, and 130.

The gap adjusting part 600 may be combined with the bezel frame 300. In an embodiment, when the shape of the display module DM is changed to a folded state, the gap adjusting part 600 may adjust a spacing (or a gap) between the plates 110, 120, and 130.

In an embodiment, the gap adjusting part 600 may fix the plates 110, 120, and 130 in a state where the plates 110, 120, and 130 contact with each other when the display module DM attached the plates 110, 120, and 130 is completely folded. In other words, the gap adjusting part 600 may fix the plates 110, 120, and 130 to be substantially parallel to each other when the display module DM is completely folded.

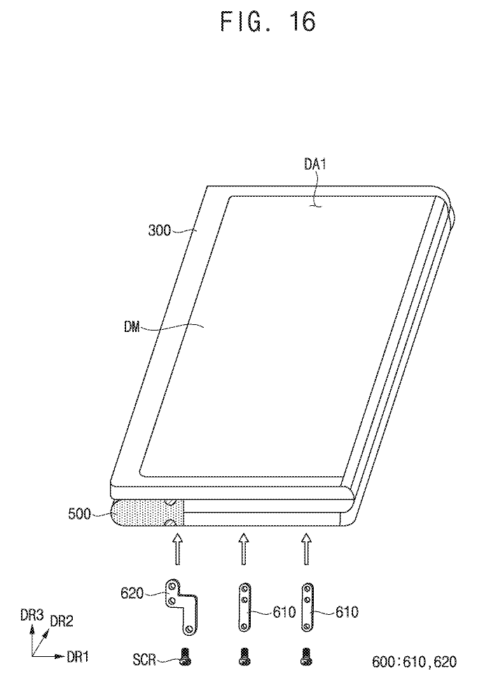

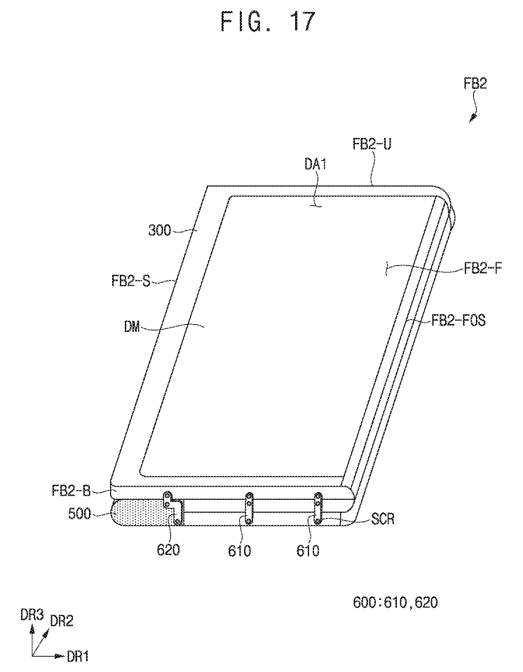

In an embodiment, the gap adjusting part 600 may fix the plates 110, 120, and 130 in a state where the plates 110, 120, and 130 are spaced apart from each other by an interval (e.g., a predetermined interval) when the display module DM attached to the plates 110, 120, and 130 is not completely folded. In other words, the gap adjusting part 600 may fix the plates 110, 120, and 130 in a state where the plates 110, 120, and 130 are not substantially parallel to each other when the display module DM is not completely folded. A detailed description thereof will be described below with reference to FIGS. 16 and 17.

FIGS. 4-9, and 10 are views illustrating a method of combining the jig of FIG. 3 with a display module. For example, FIGS. 4-10 are views illustrating how the jig JG is combined with the display module DM to fix the display module DM in an unfolded state.

Referring to FIG. 4, the first to third plates 110, 120, and 130 of the main frame 100 may be rested on the attachment guide 200. For example, the attachment guide 200 may define the resting grooves LH, and the first to third plates 110, 120, and 130 may be rested on the resting grooves LH, respectively. That is, the second surfaces of the first to third plates 110, 120, and 130 may contact the attachment guide 200.

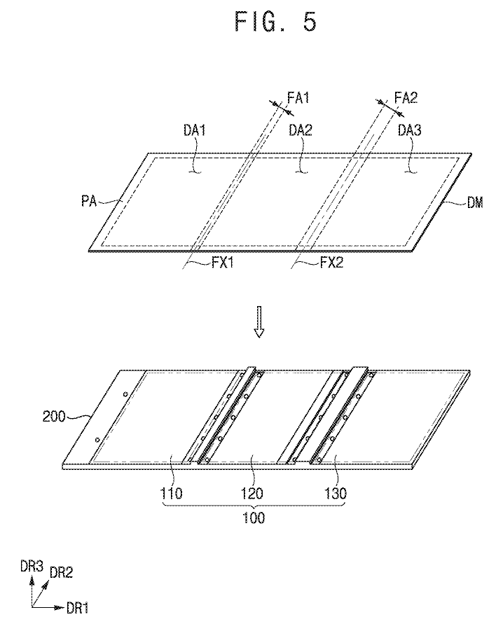

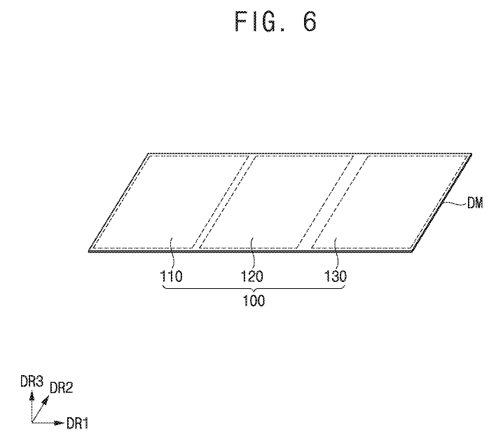

Referring further to FIGS. 5 and 6, the display module DM may be attached to the main frame 100. The main frame 100 may serve a role similar to a housing that covers the back surface of the display module DM when the display module DM is applied to an actual electronic device.

In an embodiment, when the first to third plates 110, 120, and 130 are rested on the attachment guide 200, the display module DM may be attached to the first surfaces of the first to third plates 110, 120, and 130. However, the present disclosure is not necessarily limited thereto. When the attachment guide 200 is omitted, the display module DM may be aligned with the main frame 100 using various alignment means known in the art, and may be attached to the first to third plates 110, 120, and 130.

The first to third plates 110, 120, and 130 may correspond to the first to third display areas DA1, DA2, and DA3 of the display module DM, respectively. That is, the first plate 110 may overlap the first display area DA1 in a plan view, the second plate 120 may overlap the second display area DA2 in a plan view, and the third plate 130 may overlap the third display area DA3 in a plan view.

As illustrated in FIG. 6, after the display module DM is attached to the first surfaces of the first to third plates 110, 120, and 130, the attachment guide 200 may be removed.

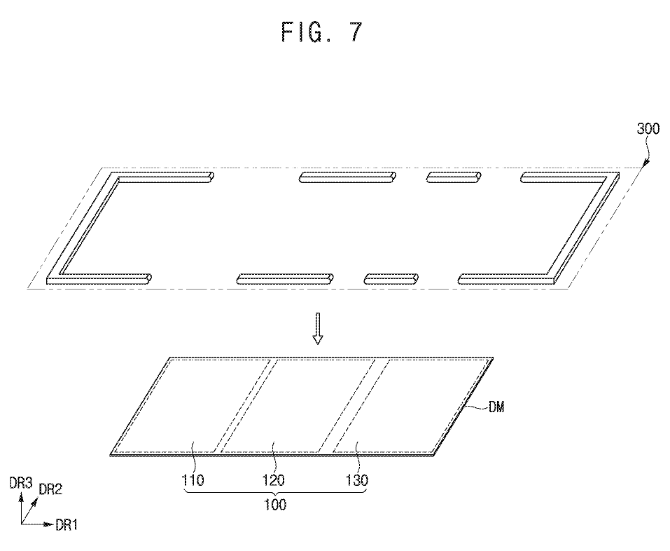

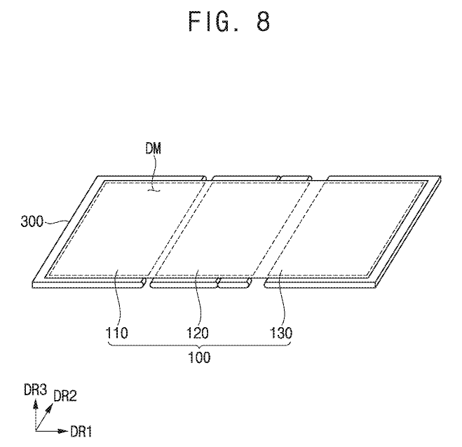

Referring further to FIGS. 7 and 8, the bezel frame 300 may be combined with the main frame 100. For example, by combining a coupling member (e.g., a coupling member SCR of FIG. 16) to a screw hole formed in the main frame 100, the bezel frame 300 may be combined with the main frame 100. In this case, the bezel frame 300 may surround at least a portion of the main frame 100 in a plan view. In addition, the bezel frame 300 may surround at least a portion of the display module DM in a plan view. The bezel frame 300 may correspond to the peripheral area PA of the display module DM. The bezel frame 300 may serve a role similar to a housing that covers the peripheral area PA of the display module DM when the display module DM is applied to an actual electronic device.

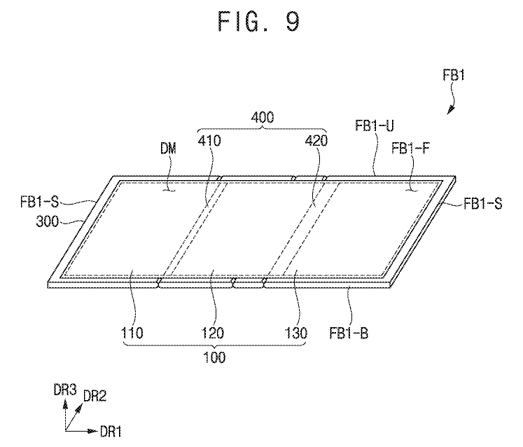

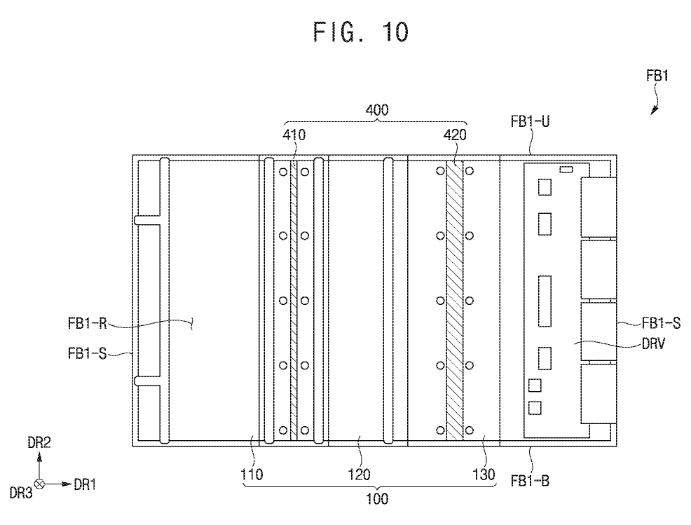

Referring further to FIGS. 9 and 10, the hinge 400 may be combined with the main frame 100. For example, the hinge 400 may be combined with the second surfaces of the first to third plates 110, 120, and 130. FIG. 10 is a rear view showing the second surfaces of the first to third plates 110, 120, and 130. The hinge 400 may be connected to a hinge axis of each pair of adjacent plates of the first to third plates 110, 120, and 130 and may connect the adjacent plates. In an embodiment, the hinge 400 may include a first hinge 410 and a second hinge 420 that are spaced apart from each other.

The first hinge 410 may be connected to a hinge axis of each of the first plate 110 and the second plate 120, and may connect the first plate 110 and the second plate 120. The second hinge 420 may be connected to a hinge axis of each of the second plate 120 and the third plate 130, and may connect the second plate 120 and the third plate 130. For example, the first hinge 410 may correspond to the first folding area FA1 of the display module DM, and the second hinge 420 may correspond to the second folding area FA2 of the display module DM.

In an embodiment, a first width (e.g., a length in the first direction DR1) of the first hinge 410 and a second width of the second hinge 420 may be different from each other. For example, as illustrated in FIG. 10, the first width of the first hinge 410 may be smaller than the second width of the second hinge 420. However, the present disclosure is not necessarily limited thereto, and the first width of the first hinge 410 may be greater than the second width of the second hinge 420. The first width of the first hinge 410 may vary depending on the first radius of curvature in the first folding area FA1, and the second width of the second hinge 420 may vary depending on the second radius of curvature in the second folding area FA2.

In an embodiment, the first hinge 410 and the second hinge 420 may fix the unfolded state of the display module DM attached to the first to third plates 110, 120, and 130.

In an embodiment, the jig JG may further include a driver DRV for driving inspection of the display module DM. The driver DRV may be electrically connected to the display module DM. After a drop impact test is performed by the impact test apparatus (ITA, see FIG. 1), the driver DRV may inspect whether the display module DM is driven normally.

The driver DRV may be bent and positioned on the back surface of the main frame 100. For example, the driver DRV may be positioned on the second surface of the third plate 130. In an embodiment, the jig JG may further include a cover member for protecting the driver DRV. The cover member may cover the driver DRV.

Accordingly, the first falling object FB1 that is dropped by the impact test apparatus may be configured. The display module DM included in the first falling object FB1 may be in an unfolded state. The first falling object FB1 may have a set environment similar to the unfolded state of the foldable electronic device when applied to an actual foldable electronic device.

FIGS. 11-16, and 17 are views illustrating a method of combining the jig of FIG. 3 with a display module. For example, FIGS. 11-17 are views illustrating how the jig JG is combined with the display module DM to fix the display module DM in a folded state.

Referring to FIGS. 9 and 11, in order to change the shape of the display module DM, the hinge 400 combined with the main frame 100 may be removed. For example, the first hinge 410 combined with the second surface of the first plate 110 and the second surface of the second plate 120 may be removed, and the second hinge 420 combined with the second surface of the second plate 120 and the second surface of the third plate 130 may be removed.

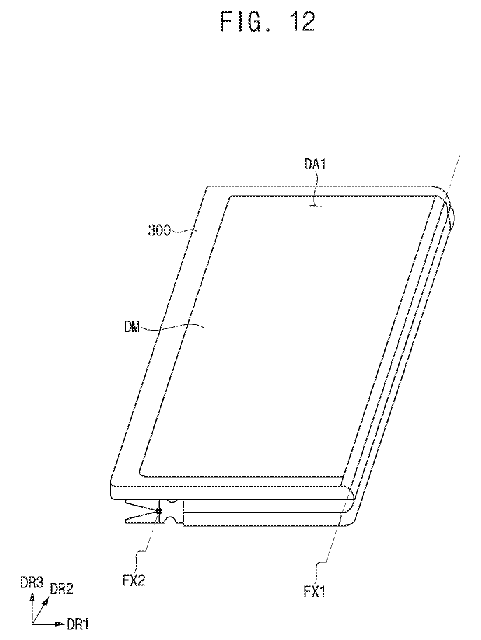

Referring further to FIG. 12, while the display module DM is attached to the main frame 100, the bezel frame 300 and the display module DM may be folded. In an embodiment, as illustrated in FIG. 12, the display module DM may be out-folded with respect to the first folding axis FX1 and in-folded with respect to the second folding axis FX2.

In an embodiment, after the first falling object (FB1, see FIG. 9) is formed and the hinge 400 is removed, the bezel frame 300 and the display module DM may be folded. However, the present disclosure is not necessarily limited thereto. As illustrated in FIG. 8, after the bezel frame 300 is combined with the main frame 100, the bezel frame 300 and the display module DM may be folded without combining the hinge 400.

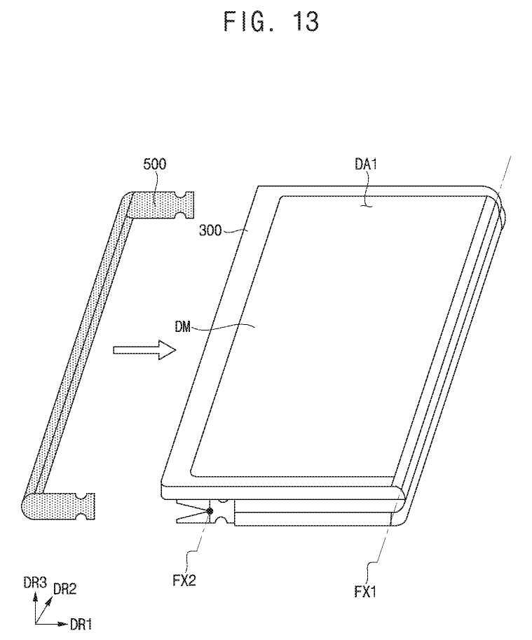

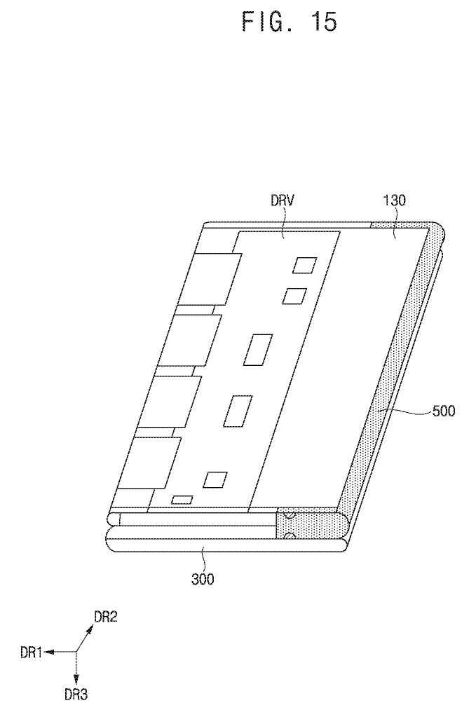

Referring further to FIGS. 13, 14, and 15, the folding fixing part 500 may be combined with the bezel frame 300. For example, by combining a coupling member to a screw hole formed in the bezel frame 300, the folding fixing part 500 may be combined with the bezel frame 300. The folding fixing part 500 may fix a folded state of the display module DM attached to the bezel frame 300 and the main frame 100. FIG. 15 is a rear perspective view showing the second surface of the third plate 130.

Referring further to FIGS. 16 and 17, the gap adjusting part 600 may be combined with the bezel frame 300. For example, a through hole may be defined in the gap adjusting part 600. By aligning a screw hole formed in the bezel frame 300 and the through hole of the gap adjusting part 600 and combining a coupling member SCR to the screw hole and the through hole, the gap adjusting part 600 may be combined with the bezel frame 300. The gap adjusting part 600 may adjust a spacing (or a gap) between the first and third plates 110, 120, and 130.

In an embodiment, the gap adjusting part 600 may include a first gap adjusting part 610 and a second gap adjusting part 620. For example, the first gap adjusting part 610 may have a straight-line shape, and the second gap adjusting part 620 may have a Z-shaped shape. For example, the second gap adjusting part 620 may include a first portion extending in the first direction DR1, a second portion connected to a first end of the first portion and extending in the third direction DR3, and a third portion connected to a second end different from the first end of the first portion and extending in an opposite direction of the third direction DR3. However, the present disclosure is not necessarily limited thereto. In another embodiment, the gap adjusting part 600 may further include a third gap adjusting part having a T-shaped shape.

In an embodiment, the gap adjusting part 600 may fix the plates 110, 120, and 130 in a state where the plates 110, 120, and 130 contact with each other when the display module DM attached to the plates 110, 120, and 130 is completely folded. In other words, the gap adjusting part 600 may fix the plates 110, 120, and 130 to be substantially parallel to each other when the display module DM is completely folded. For example, the first gap adjusting part 610 may be combined with the bezel frame 300 in a state in which the first to third plates 110, 120, and 130 contact with each other. Accordingly, the second falling object FB2 dropped by the impact test apparatus (ITA, see FIG. 1) may be configured. In this case, the display module DM included in the second falling object FB2 may be in a state in which the display module DM is completely folded into a Z-shape. The second falling object FB2 may have a set environment similar to a state in which the foldable electronic device is completely folded into a Z-shape when applied to an actual foldable electronic device.

In an embodiment, the gap adjusting part 600 may fix the plates 110, 120, and 130 in a state where the plates 110, 120, and 130 are spaced apart from each other by an interval (e.g., a predetermined interval) when the display module DM attached to the plates 110, 120, and 130 is not completely folded. In other words, the gap adjusting part 600 may fix the plates 110, 120, and 130 in a state where the plates 110, 120, and 130 are not substantially parallel to each other when the display module DM is not completely folded. For example, the first gap adjusting part 610 may be combined with the bezel frame 300 in a state in which the first plate 110 and the second plate 120 are spaced apart from each other by an interval (e.g., a predetermined interval). For another example, the first gap adjusting part 610 may be combined with the bezel frame 300 in a state in which the second plate 120 and the third plate 130 spaced apart from each other by an interval (e.g., a predetermined interval). For still another example, the second gap adjusting part 620 may be combined with the bezel frame 300 in a state in which the first plate 110 and the second plate 120 are spaced apart from each other by an interval (e.g., a predetermined interval), and the second plate 120 and the third plate 130 are spaced apart from each other by an interval (e.g., a predetermined interval). Accordingly, the second falling object FB2 that is dropped by the impact test apparatus (IPA, see FIG. 1) may be configured. In this case, the display module DM included in the second falling object FB2 may be in a state that is not completely folded. The second falling object FB2 may have a set environment similar to a state in which the foldable electronic device is not completely folded (e.g., a half-open state) when applied to an actual foldable electronic device. For example, the second falling object FB2 may have a set environment similar to a state in which the foldable electronic device is not completely folded due to an object such as a card, coin, pen, or the like being inserted between portions in which the foldable electronic device is folded.

The jig JG according to embodiments of the present disclosure may be combined with the display module DM and may change the shape of the display module DM. In an embodiment, the display module DM may be folded in a Z-shape by being out-folded with respect to the first folding axis FX1 and in-folded with respect to the second folding axis FX2.

The falling object (FB, see FIG. 1) formed by combining the jig JG and the display module DM may have a set environment similar to a foldable electronic device that operates in a plurality of usage modes. That is, an evaluation of defects occurring in an actual usage environment of the display module DM that operates in multiple usage modes may be performed using the jig JG.

For example, an evaluation of defects occurring in an actual usage environment of the display module DM that operates in an unfolded state may be performed using the first falling object (FB1, see FIG. 9).

For example, an evaluation of defects occurring in an actual usage environment of the display module DM that operates in a completely Z-folded state may be performed using the second falling object FB2.

For example, an evaluation of defects occurring in an actual usage environment of the display module DM that operates in a not completely folded state may be performed using the second falling object FB2. Examples of the state in which the display module DM is not completely folded may include a case in which a first portion of the display module DM overlapping the first display area DA1 and a second portion of the display module DM overlapping the second display area DA2 are spaced apart, a case in which a third portion of the display module DM overlapping the third display area DA3 and the second portion of the display module DM are spaced apart, a case in which the first portion, the second portion, and the third portion of the display module DM are spaced apart from each other, or the like. In other words, the state in which the display module DM is not completely folded may be a state in which the first display area DA1, the second display area DA2, and the third display area DA3 are not substantially parallel from each other (e.g., an angle formed between the first display area DA1 and the second display area DA2 is greater than 2 degrees and less than 179 degrees or an angle formed between the second display area DA2 and the third display area DA3 is greater than 2 degree and less than 179 degrees). On the other hand, a state in which the display module DM is completely folded may be a state in which the first display area DA1, the second display area DA2, and the third display area DA3 are substantially parallel from each other.

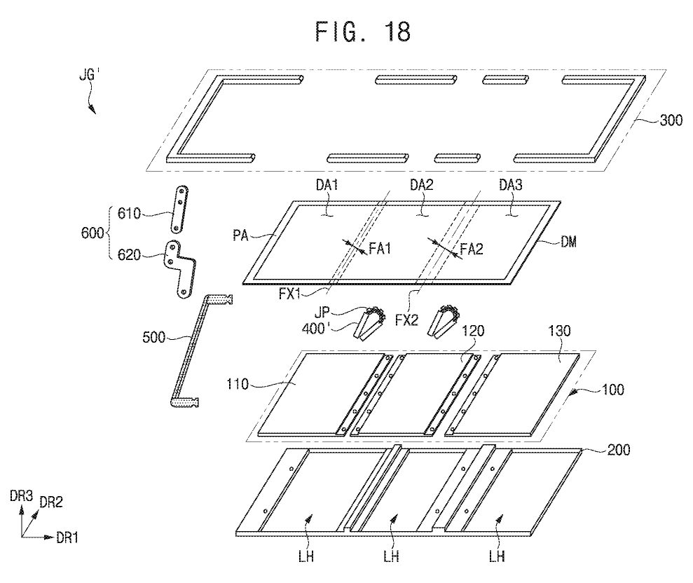

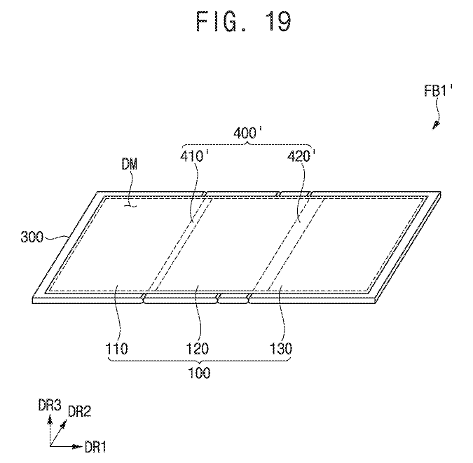

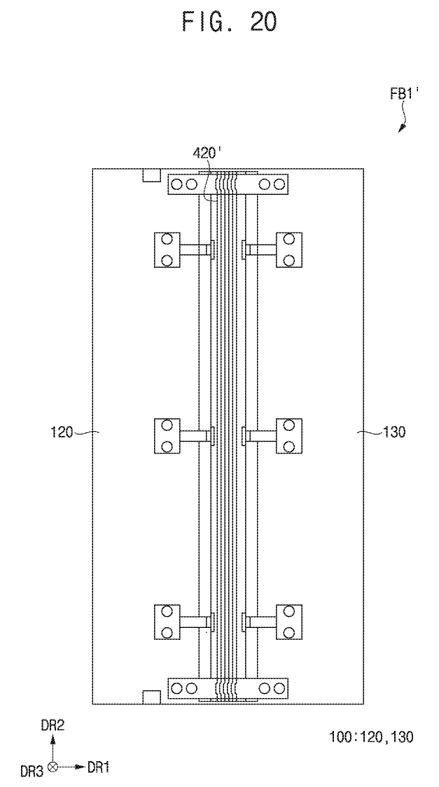

FIG. 18 is an exploded perspective view illustrating a jig according to an embodiment of the present disclosure. FIGS. 19 and 20 are view illustrating a method of combining the jig of FIG. 18 with a display module.

Referring to FIG. 18, a jig JG` according to an embodiment of the present disclosure may include a main frame 100, an attachment guide 200, a bezel frame 300, a hinge 400`, a folding fixing part 500, and a gap adjusting part 600.

The jig JG` may be substantially the same as the jig JG described above with reference to FIGS. 3-17, except that the hinge 400` includes joint portions JP. Hereinafter, redundant descriptions of the jig JG described above with reference to FIGS. 3-17 are omitted or summarized.

Referring further to FIGS. 19 and 20, the hinge 400` may be combined with the main frame 100. For example, the hinge 400` may be combined with second surfaces (e.g., back surfaces) of first to third plates 110, 120, and 130. The hinge 400` may be connected to a hinge axis of each pair of adjacent plates of the first to third plates 110, 120, and 130, and may connect the adjacent plates. In an embodiment, the hinge 400` may include a first hinge 410` and a second hinge 420`.

The first hinge 410` may be connected to a hinge axis of each of the first plate 110 and the second plate 120, and may connect the first plate 110 and the second plate 120. The second hinge 420` may be connected to a hinge axis of each of the second plate 120 and the third plate 130, and may connect the second plate 120 and the third plate 130. For example, the first hinge 410` may correspond to the first folding area FA1 of the display module DM, and the second hinge 420` may correspond to the second folding area FA2 of the display module DM.

In an embodiment, a first width (e.g., a length in the first direction DR1) of the first hinge 410` and a second width of the second hinge 420` may be different from each other. For example, as illustrated in FIG. 19, the first width of the first hinge 410` may be smaller than the second width of the second hinge 420`. However, the present disclosure is not necessarily limited thereto.

In an embodiment, each of the first hinge 410` and the second hinge 420` may include the joint portions JP. In this case, the first hinge 410` and the second hinge 420` may fix an unfolded state of the display module DM attached to the first to third plates 110, 120, and 130. In addition, when the shape of the display module DM is changed in order to fold the display module DM, the first hinge 410` and the second hinge 420` may be bent together with the display module DM. In other words, when changing the shape of the display module DM, the hinge 400` may be bent together with the display module DM without being removed.

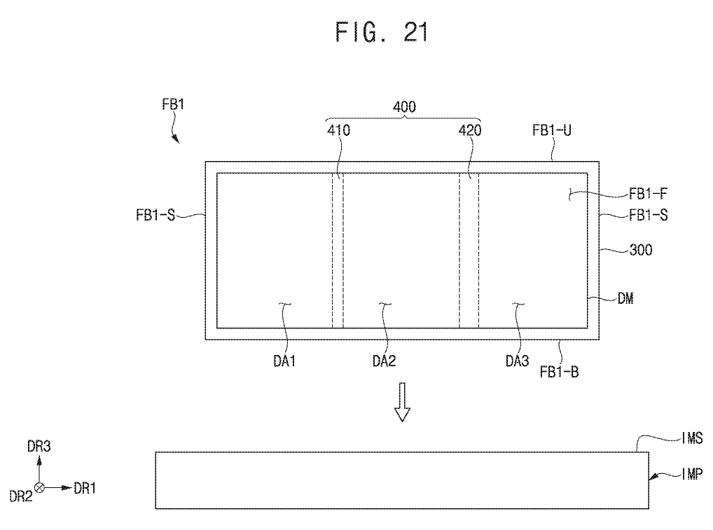

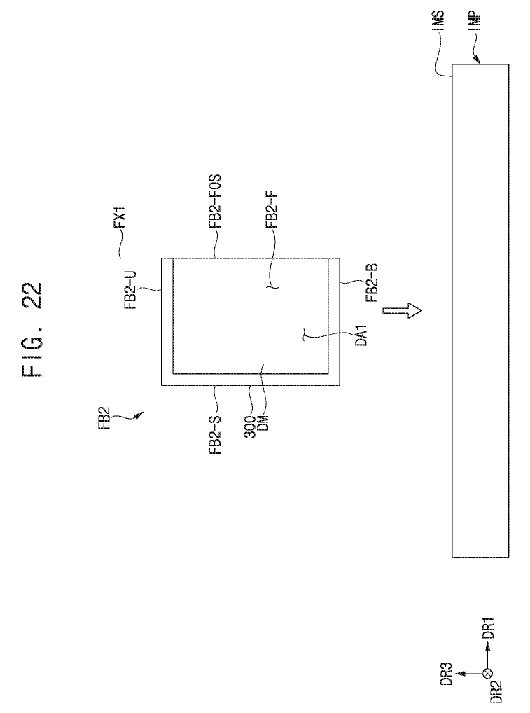

FIGS. 21 and 22 are cross-sectional views illustrating some steps of an impact test method according to an embodiment of the present disclosure.

Referring to FIGS. 9, 10, and 21, the first falling object FB1 that is dropped by the impact test apparatus (ITA, see FIG. 1) may be configured. In an embodiment, the display module DM included in the first falling object FB1 may be in an unfolded state. That is, the impact test apparatus may evaluate whether defects occur due to a collision caused by dropping in an actual usage environment of the display module DM that operates in an unfolded state by using the first falling object FB1. The descriptions of a method in which the jig JG is combined with the display module DM described above with reference to FIGS. 4-10 may be equally applied to the descriptions of a method for configuring the first falling object FB1.

An impact test method according to an embodiment of the present disclosure may include dropping the first falling object FB1 toward the impact plate IMP. For example, as illustrated in FIG. 21, the first falling object FB1 may be dropped such that a lower surface FB1-B of the first falling object FB1 collides with the impact plate IMP, but the present disclosure is not limited thereto. The dropping the first falling object FB1 may be repeated multiple times, and each of an upper surface FB1-U, two side surfaces FB1-S, a front surface FB1-F, and a back surface FB1-R of the first falling object FB1 may collide with the impact plate IMP in multiple drop test steps. Accordingly, the evaluation of defects that occur when the display module DM is dropped in various directions in an actual use environment in which the display module DM is operated in an unfolded state may be performed.

After the dropping the first falling object FB1 toward the impact plate IMP, inspecting an appearance of the first falling object FB1 and inspecting whether the display module DM is operating may be performed.

Referring to FIGS. 17 and 22, the second falling object FB2 that is dropped by the impact test apparatus may be configured. In an embodiment, configuring the second falling object FB2 may be performed after configuring the first falling object FB1. That is, after configuring the first falling object FB1, the second falling object FB2 may be configured by changing the shape of the display module DM using the jig JG. However, the present disclosure is not necessarily limited thereto.

In an embodiment, the display module DM included in the second falling object FB2 may be in a completely Z-folded state. In another embodiment, the display module DM included in the second falling object FB2 may be in a state that is not completely folded. That is, the impact test apparatus may evaluate whether defects occur due to a collusion caused by dropping in an actual usage environment of the display module DM that operates in a folded state by using the second falling object FB2. The descriptions of a method in which the jig JG is combined with the display module DM described above with reference to FIGS. 11-17 may be equally applied to the descriptions of a method for configuring the second falling object FB2.

An impact test method according to an embodiment of the present disclosure may further include dropping the second falling object FB2 toward the impact plate IMP. For example, as illustrated in FIG. 22, the second falling object FB2 may be dropped such that a lower surface FB2-B of the second falling object FB2 collides with the impact plate IMP, but the present disclosure is not necessarily limited thereto. The dropping the second falling object FB2 may be repeated multiple times, and each of an upper surface FB2-U, a first side surface FB2-S, a second side surface FB2-FOS, a front surface FB2-F, and a back surface of the second falling object FB2 may collide with the impact plate IMP in multiple drop test steps. In this case, the second side surface FB2-FOS of the second falling object FB2 may be a side surface overlapping the first folding axis FX1, and the first side surface FB2-S of the second falling object FB2 may be a side surface opposite to the second side surface FB2-FOS. Accordingly, the evaluation of defects that occur when the display module DM is dropped in various directions in an actual use environment in which the display module DM is operated in a folded state may be performed.

After the dropping the second falling object FB2 toward the impact plate IMP, inspecting an appearance of the second falling object FB2 and inspecting whether the display module DM is operating may be performed.

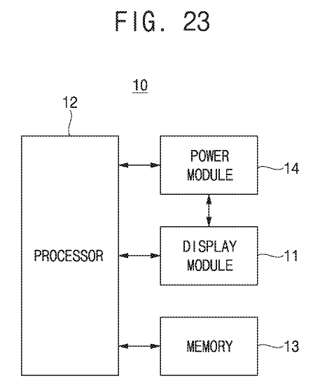

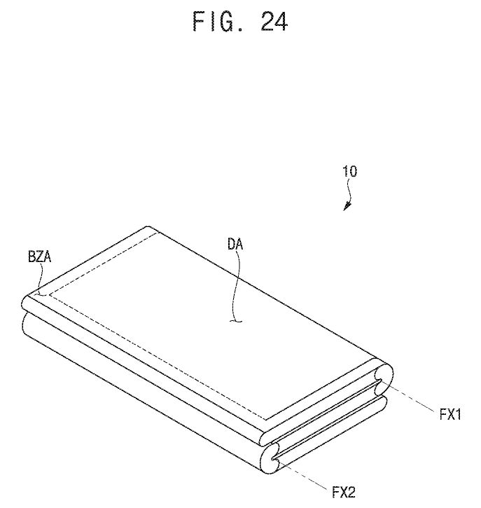

FIG. 23 is a block diagram of an electronic device according to an embodiment of the present disclosure. FIG. 24 is a view illustrating an example of the electronic device of FIG. 23 is implemented as a foldable electronic device.

Referring to FIGS. 23 and 24, an electronic device 10 according to an embodiment may include a display module 11, a processor 12, a memory 13, and a power module 14. The display module 11 may correspond to the display module (DM, see FIG. 3) described above evaluated by the impact test apparatus (ITA, see FIG. 1). The electronic device 10 according to an embodiment may include the display device described above, and may further include modules or devices having other additional functions in addition to the display device.

The processor 12 may include at least one of a central processing unit (CPU), an application processor (AP), a graphic processing unit (GPU), a communication processor (CP), an image signal processor (ISP), and a controller.

The memory 13 may store data information required for operation of the processor 12 or the display module 11. When the processor 12 executes an application stored in the memory 13, an image data signal and/or an input control signal may be transmitted to the display module 11, and the display module 11 may process the received signals and may output image information through a display screen.

The power module 14 may include a power supply module, such as a power adapter or a battery device, etc., and a power conversion module that converts power supplied by the power supply module to generate the power required for operation of the electronic device 10. That is, the power module 14 may provide power to the display device according to the embodiments described above.

At least one of the components of the electronic device 10 described above may be included in the display device according to the embodiments described above. In addition, some of the individual modules that are functionally included in one module may be included in the display device and others may be provided separately from the display device. For example, the display device may include the display module 11, and the processor 12, the memory 13, and the power module 14 may be provided in the form of other devices in the electronic device 10 other than the display device.

In an embodiment, as illustrated in FIG. 24, the electronic device 10 may be implemented as a foldable electronic device. For example, the electronic device 10 may be implemented as a foldable smartphone. In this case, the electronic device 10 may include a display area DA that displays an image and a bezel area BZA surrounding the display area DA. The bezel area BZA may not display the image. The electronic device 10 may be out-folded with respect to a first folding axis FX1 and in-folded with respect to a second folding axis FX2. However, this is exemplary, and the electronic device 10 is not necessarily limited thereto. For example, the electronic device 10 may be implemented as a tablet PC, a laptop, a gaming console, a car navigation system, a computer monitor, or the like.

The present disclosure may be applied to various display devices. For example, the present disclosure is applicable to various display devices such as display devices for vehicles, ships and aircraft, portable communication devices, display devices for exhibition or information transmission, medical display devices, and the like.

The foregoing is illustrative of the embodiments of the present disclosure, and is not to be construed as limiting thereof. Although a few embodiments have been described with reference to the figures, those skilled in the art will readily appreciate that many variations and modifications may be made therein without departing from the spirit and scope of the present disclosure as defined in the appended claims.

What is claimed is:

1. A jig comprising:
a main frame comprising a plurality of plates, each of the plurality of plates having a first surface, to which a display module is attached, and a second surface opposite to the first surface;
a bezel frame combined with the main frame and surrounding at least a portion of the main frame in a plan view;
a hinge combined with the second surfaces of the plurality of plates, connecting adjacent plates of the plurality of plates, and capable of fixing an unfolded state of the display module; and
a folding fixing part combined with the bezel frame and capable of fixing a folded state of the display module.

2. The jig of claim 1, further comprising:
a gap adjusting part, which is combined with the bezel frame and adjusts a gap between the plurality of plates.

3. The jig of claim 2, wherein the gap adjusting part comprises:
a first gap adjusting part having a straight-line shape; and
a second gap adjusting part having a Z-shape.

4. The jig of claim 1,
wherein the hinge comprises a first hinge and a second hinge spaced apart from each other, and
wherein a first width of the first hinge and a second width of the second hinge are different from each other.

5. The jig of claim 1, wherein the hinge comprises a plurality of joint portions.

6. The jig of claim 1, wherein the folding fixing part has a U- shape.

7. The jig of claim 1,
wherein the display module comprises a first display area, a second display area, a third display area, a peripheral area surrounding at least a portion of the first to third display areas in the plan view, a first folding area between the first display area and the second display area, and a second folding area between the second display area and the third display area,
wherein the plurality of plates correspond to the first to third display areas, respectively, and
wherein the bezel frame corresponds to the peripheral area.

8. The jig of claim 7,
wherein the display module is out-folded in the first folding area and in-folded in the second folding area, and
wherein the hinge comprises a first hinge corresponding to the first folding area and a second hinge corresponding to the second folding area.

9. The jig of claim 1, further comprising:
an attachment guide defining a plurality of resting grooves corresponding to the plurality of plates, respectively, the attachment guide on which the plurality of plates are rested.

10. The jig of claim 9, wherein when the plurality of plates are rested on the attachment guide, the second surfaces of the plurality of plates contact the attachment guide.

11. An impact test method, the method comprising:
providing a jig comprising a main frame, which comprises a plurality of plates, a bezel frame, a hinge, and a folding fixing part;
attaching a display module to first surfaces of the plurality of plates;
combining the bezel frame with the main frame to surround at least a portion of the main frame in a plan view;
combining the hinge with second surfaces opposite to the first surfaces of the plurality of plates to connect adjacent plates of the plurality of plates, thereby forming a first falling object comprising the display module fixed in an unfolded state;
colliding the first falling object with an impact plate;
folding the bezel frame and the display module attached to the plurality of plates;
combining the folding fixing part with the bezel frame, thereby forming a second falling object comprising the display module fixed in a folded state; and
colliding the second falling object with the impact plate.

12. The method of claim 11, wherein the jig further comprises a gap adjusting part, which adjusts a gap between the plurality of plates.

13. The method of claim 12, further comprising:
combining the gap adjusting part with the bezel frame after the folding of the bezel frame and the display module.

14. The method of claim 13,
wherein, when the display module included in the second falling object is fixed in a completely folded state, the plurality of plates of the main frame included in the second falling object are substantially parallel from each other.

15. The method of claim 13,
wherein, when the display module included in the second falling object is fixed in a not completely folded state, the plurality of plates of the main frame included in the second falling object are not substantially parallel from each other.

16. The method of claim 11, further comprising:
removing the hinge after the forming of the first falling object.

17. The method of claim 11,
wherein the hinge comprises a plurality of joint portions, and
wherein the hinge is bent together with the display module in the folding of the bezel frame and the display module.

18. The method of claim 11,
wherein the display module comprises a first display area, a second display area, a third display area, a peripheral area surrounding at least a portion of the first to third display areas in the plan view, a first folding area between the first display area and the second display area, and a second folding area between the second display area and the third display area,
wherein the display module is out-folded in the first folding area and in-folded in the second display area, and
wherein the hinge comprises a first hinge corresponding to the first folding area and a second hinge corresponding to the second folding area.

19. The method of claim 11,
wherein the colliding of the first falling object with the impact plate comprises colliding each of an upper surface, a lower surface, a side surface, a front surface, and a back surface of the first falling object with the impact plate, and
wherein the colliding of the second falling object with the impact plate comprises colliding each of an upper surface, a lower surface, a side surface, a front surface, and a back surface of the second falling object with the impact plate.
